(19) United States
(12) Patent Application Publication
(10) Pub. No.: US 2017/0171279 A1
(43) Pub. Date: Jun. 15, 2017

(54) METHOD AND TERMINAL FOR ONLINE PLAYING VIDEO STREAM

(71) Applicants: Le Holdings (Beijing) Co., Ltd., Beijing (CN); LE SHI INTERNET INFORMATION TECHNOLOGY CORP. BEIJING, Beijing (CN)

(72) Inventor: Wei Zhang, Beijing (CN)

(21) Appl. No.: 15/247,409

(22) Filed: Aug. 25, 2016

Related U.S. Application Data
(63) Continuation of application No. PCT/CN2016/088114, filed on Jul. 1, 2016.

(30) Foreign Application Priority Data
Dec. 11, 2015 (CN) 201510921181.6

(51) Int. Cl. H04L 29/06; H04N 21/44; H04N 21/61; H04N 21/2347; H04N 21/437; H04N 21/231; H04N 21/239; H04N 21/235; H04L 12/861; H04N 21/435

(52) U.S. Cl. CPC H04L 65/605; H04L 49/90; H04L 63/0428; H04N 21/44004; H04N 21/6125; H04N 21/4353; H04N 21/437; H04N 21/231; H04N 21/2393; H04N 21/2351; H04N 21/2347

(57) ABSTRACT

The disclosure provides a method and a terminal for online playing a video stream. The method includes: Acquiring slice data encrypted slice by slice from a server according to a time parameter of a video slice; Decrypting the acquired slice data to acquire the video slice. And add the video slice to a buffer for online playing. The principle of slicing is applied in the disclosure, it is to slice the original video and encrypt slice by slice to realize online playing and encryption of the video stream. Thus, the disclosure meets the requirements of real-time performance and manipulability, etc.

### CROSS-REFERENCE TO RELATED APPLICATIONS

This application is a continuation of International Application No. PCT/CN2016/088114, filed on Jul. 1, 2016, which is based upon and claims priority to Chinese Patent Application No. 201510921181.6, titled “method, electronic apparatus device and system for online playing video stream”, filed on Dec. 11, 2015, the entire contents of all of which are incorporated herein by reference.

### TECHNICAL FIELD

The disclosure relates to a technical field about playing an encrypted video, in particular relates to a method and a terminal for online playing a video stream.

### BACKGROUND

With the rapid development of global informatization, technologies of personal computers, communications, networks and multimedia, etc., are popularly applied in the life nowadays. Thus, images, audio, video and other multimedia have been widely used, such as video on demand, video conference, monitoring system, etc. Since the demand on information is increasing, the video information is not only required to have better quality, more demands on the other aspects of the video information are provided. The most obvious aspect of all is about the safety of the video information.

Conventionally, the main way adopted to deal with video information security issues is to encrypt the whole video file by using encryption algorithm. The method mentioned above has advantages of high reliability when encrypting and high video quality, etc.

However, when a user wants to watch a video encrypted by the method mentioned above, the user has to download the whole video file, and decrypts the whole video so as to play it. The method mentioned above is not suitable for online playing. Furthermore, the method is also difficult to meet the requirements of real-time performance and manipulability, etc.

### SUMMARY

In view of that above, the disclosure provides a method and a terminal for online playing a video stream to solve problem of technique that encrypted video is unable to real-time online play.

In order to solve the above technical problem, the embodiment of the disclosure provides a method for online playing a video stream applied in a terminal. The method includes: Acquiring slice data encrypted slice by slice from a server according to a time parameter of a video slice; Decrypting the acquired slice data to acquire the video slice; And adding the video slice to a buffer for online playing.

In order to solve the above technical problem, the embodiment of the disclosure provides a method for online playing a video stream applied in a server. The method includes: Storing slice data encrypted slice by slice of a video slice; Receiving a request for acquiring the slice data from a client, the request includes a time parameter of the video slice; And sending the slice data encrypted slice by slice to the client for online playing in the client.

In order to solve the above technical problem, the embodiment of the disclosure provides a terminal, including at least one processor, and a memory for storing instructions executable by the at least one processor, wherein the instructions are executed by the at least one processor to perform any one of the methods for online playing a video stream applied in a terminal mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for online playing a video stream in an embodiment of the disclosure.

FIG. 2 is a flow chart of a method for online playing a video stream in an embodiment of the disclosure.

FIG. 3 is a flow chart of a method for online playing a video stream in an embodiment of the disclosure.

FIG. 4 is a flow chart of a method for online playing a video stream in an embodiment of the disclosure.

FIG. 5 is a flow chart of a method for online playing a video stream in an embodiment of the disclosure.

FIG. 6 is a flow chart of a method for online playing a video stream in an embodiment of the disclosure.

FIG. 7 is a flow chart of a method for online playing a video stream in an embodiment of the disclosure.

FIG. 8 is a block diagram of a device for online playing a video stream in an embodiment of the disclosure.

FIG. 9 is a block diagram of a device for online playing a video stream in an embodiment of the disclosure.

FIG. 10 is a block diagram block diagram of a terminal for online playing a video stream in an embodiment of the disclosure.

FIG. 11 is a block diagram block diagram of a server for online playing a video stream in an embodiment of the disclosure.

FIG. 12 is a block diagram of a system for online playing a video stream in an embodiment of the disclosure.

### DETAILED DESCRIPTION

In order to present the purposes, technical solutions and advantages in the embodiments of the disclosure more clearly, the technical solutions in the embodiments of the disclosure as set forth below are described clearly and completely in conjunction with the accompanying drawings of the embodiments of the disclosure. It is obvious that the described embodiments are merely a part of the embodiments of the disclosure, but not all. Based on the embodiments of the disclosure, all other embodiments obtained by those of ordinary skill in the art without making creative efforts are also within the scope of the disclosure.

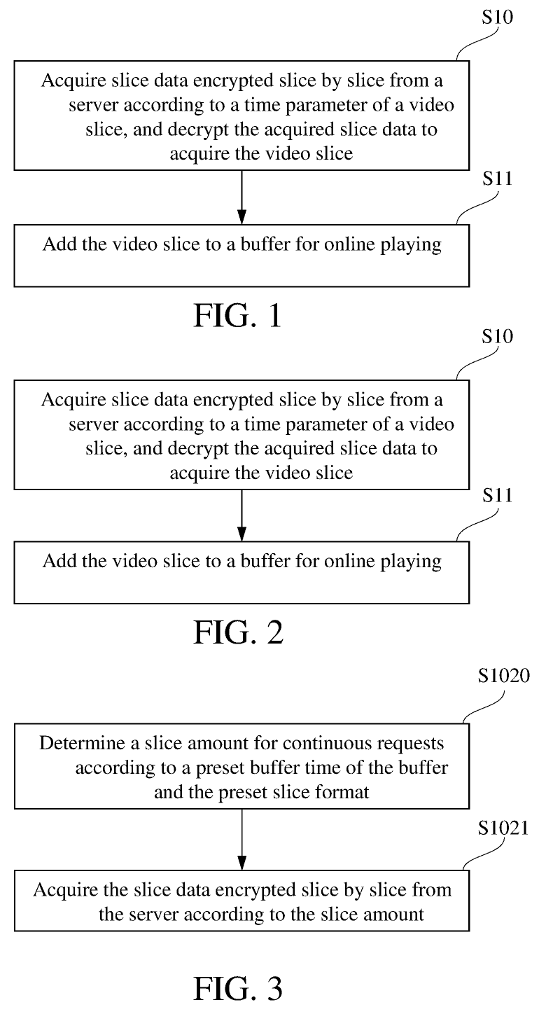

FIG. 1 is a flow chart of a method for online playing a video stream in an embodiment of the disclosure. The method for online playing the video stream in the embodiment is suitable for terminal equipment. The terminal equipment may be a mobile phone, a computer, a game console, an automotive console, a tablet device, a medical equipment, a fitness equipment, a personal digital assistants and the like.

As shown in FIG. 1, the method includes following steps S10-S11.

In the step S10, slice data encrypted slice by slice from a server is acquired according to a time parameter of a video slice, and the acquired slice data is decrypted to acquire the video slice.

First, choose kinds of video to play, such as a movie, TV show, variety show, etc., and then use ffmpeg (Fast Forward Mpeg) or another video cutting tool to slice the video to play to acquire a plurality of slices. For example, based on a 60-second video and each of the slices corresponding to 5 second, 12 slice files are generated after slicing. After that, encrypt each of the slices slice by slice. The encrypted slices are formed slice data in order of time, and the slice data is stored in a server for being requested for playing.

The video encrypting operation mainly includes a whole encryption and a partial encryption. According to the method of the embodiment, all the slices of the whole video stream are encrypted, and each of the encrypted slices are stored in the server in order of time.

The terminal equipment acquires the slice data encrypted slice by slice from the server according to the time parameter of the video slice, and decrypts the acquired slice data to acquire the video slice.

In the step S11, the video slice is added to a buffer for online playing.

The acquired video slice is added to the buffer in order of time, and is online played successively in chronological order. The played video may be a whole content or a part content of a movie, TV show, variety show, etc. A point at which starts to play or a point at which stops playing of the video is determined by the user. A start point or a stop point of the video is determined by the user. The buffer is empty when the video is played at the beginning. As the playing progress goes on, data in the buffer is endeavored to be added.

The terminal equipment adds the video slice to the buffer for online playing.

In the embodiment, the terminal equipment acquires the slice data encrypted slice by slice from the server according to the time parameter of the video slice, decrypts the acquired slice data to acquire the video slice, and adds the video slice to the buffer for online playing. Every time when the video is started to play, the time t is set to 0. As the playing progress goes on, the time parameter t is updated, and the slice data is requested for sending. For example, when playing the video at the beginning, the video player requests for one of the slices based on the time parameter t=0, then the backend server returns the first slice. After acquiring the first slice, the video player requests for other slices based on t=1×slice format and t=2×slice format, then the backend server returns the corresponding second and third slices. The video player acquires the slice data and decrypts it. In the process above, the principle of slicing is applied, it is to slice the original video to acquire a plurality of slices, encrypt each of the slices, then decrypt each of the slices and add them to the buffer for online playing. In this way, it is easy to realize the encryption of the video and convenient to switch the code rate and video resolution. The user can encrypt and online play the video stream without purchasing complex commercial digital rights management (DRM).

In an embodiment, as shown in FIG. 2, the step S10 is further implemented as the flowing steps S100-S103.

In the step S100, a request of the slice data of a video stream is sent to the server.

In the step S101, a preset slice format of the video stream is acquired from the server.

When the server transcodes the whole video file into a slice stream for online playing, the server sets a slice interface, the slice format of the video stream is specified in the slice interface. In the slice format, length of each of the slices may be the same or different. For example, one slice is corresponding to 5 second, or one slice is corresponding to 10 second and so on. The length of each of the slices may be irregular. For example, the first slice is corresponding to 2 second, the second slice is corresponding to 4 second, and the third and other slices are corresponding to 5 second. The examples above are just exemplary explanations for the slice format, but do not limit the scope of application.

In the step S102, the time parameter of the video slice is determined according to the preset slice format and the slice data encrypted slice by slice is acquired from the server.

For example, based on the acquired slice format, if of the first slice is 2 second, the second slice is 4 second, and the third and other slices are 5 second, the time parameters used for acquiring slice data are t=0, t=2, t=6, t=11, t=16 Thus, the slice data is acquired according to the time parameter determined.

In the step S103, the acquired slice data is decrypted to acquire video slice.

In the embodiment, the slice format of the video stream is acquired first, because it is beneficial to acquire the slice data fast. Especially when dealing with a video stream with different lengths of slices, it is more beneficial to request the server for the slice data fast and accurately.

In an embodiment, as shown in FIG. 3, the step S102 is further implemented as the following steps S1020-S1021.

In the step S1020, a slice amount for continuous requests is determined according to a preset buffer time of the buffer and the preset slice format.

For example, if the preset buffer time is 15 second and the preset slice format is 5 second, the slice amount for continuous requests is 3, that is, to successively request for the slice data corresponding to t=0, t=5, t=10, and add the requested slice data to the buffer. The examples above are just exemplary explanations for the slice amount for continuous requests, but do not limit the scope of the disclosure.

In the step S1021, the slice data encrypted slice by slice is acquired from the server according to the slice amount.

For example, if the slice amount is 3 and the preset slice format is 5 second, the slice data encrypted slice by slice and acquired successively from the server is corresponding to t=0, t=5, t=10. The examples above are just exemplary explanations for the slice data acquired successively, but do not limit the scope of disclosure.

In the embodiment, the slice data to be acquired successively is determined according to the buffer time and the slice format. It is beneficial to acquire buffer data faster, and shorten the waiting time from loading to online playing the video. Thus, improve the user's watching experience.

In an embodiment, the method further includes the following steps S12-S13.

In the step S12, the time parameter closest to a target timing of an adjusting operation for playing progress is determined when the adjusting operation for the playing progress is detected.

When the user performs the adjusting operation for the playing progress(seek operation), the video player clears the buffer first, and determines a key time point closest to the target timing to send a plurality of requests, the number of the requests to send is determined according to the slice amount for continuous requests. For example, the number of the requests is 3.

For example, when the user performs the seek operation by using the progress bar of the video player and dragging the progress bar to 26 second, the terminal equipment deals with the corresponding timing. In detail, the terminal equipment determines a multiple of the slice format closest to the time point. For example, when the slice format is 5 second, the time parameter closest to 26 second is t=25.

In the step S13, the slice data from the server is acquired according to the closest time parameter.

For example, if the time parameter closest to 26 second is t=25, the slice data of time parameter t=25 is acquired from the server.

In the embodiment, the user can achieve the operations of fast forward online playing, fast rewind online playing and online playing based on a specific time, etc. Thus, the embodiment meets the requirements of real-time performance and manipulability, etc.

In an embodiment, the step S13 is further implemented as the following steps S130-S132.

In the step S130, the buffer is cleared.

Before the step of acquiring the slice data from the server according to the closest time parameter, all the data in the buffer are cleared to facilitate the placement of the acquired slice data.

In the step S131, the slice data from the server is acquired according to the closest time parameter, and decrypt the acquired slice data to acquire the video slice corresponding to the closest time parameter.

In the step S132, the video slice corresponding to the closest time parameter is added to the buffer.

In the embodiment, before the step of acquiring the slice data corresponding to the time parameter closest to the target timing, the buffer is cleared. It is beneficial for fast buffering the slice data starting form the time parameter closest to the target timing, shortening the waiting time from loading to online playing the video, and the user's watching experience is improved.

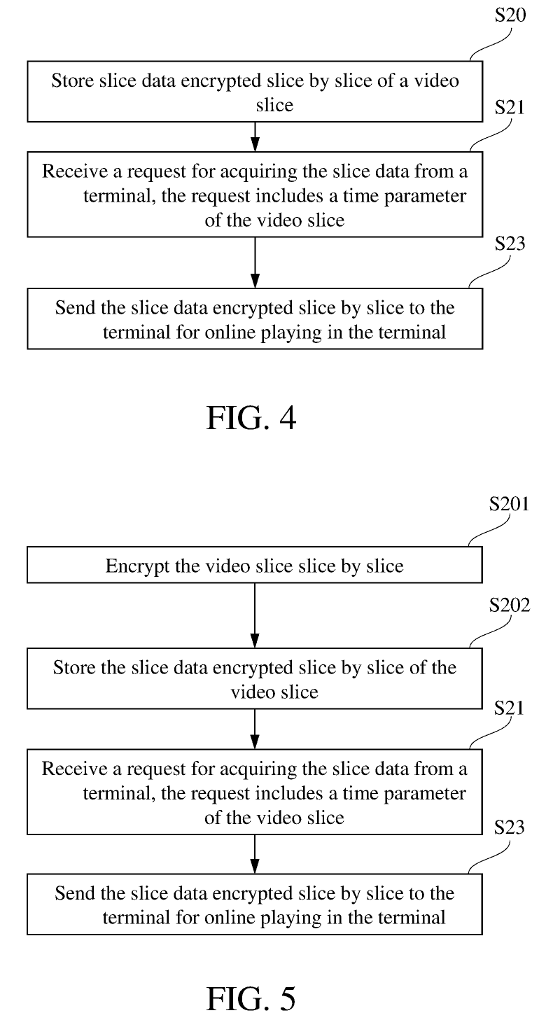

FIG. 4 is a flow chart of a method for online playing a video stream in an embodiment of the disclosure. The method for online playing the video stream in the embodiment is suitable for a server. The method includes the following steps S20-S22.

In the step S20, slice data encrypted slice by slice of a video slice is stored.

All the video slices of the video stream have been encrypted slice by slice and been stored in the server in order of time.

In the step S21, a request for acquiring the slice data is received from a client, the request includes a time parameter of the video slice.

The request for acquiring the slice data includes a flag of the video stream. The server determines the video stream requested by the client according to the flag. The request for acquiring the slice data further includes the time parameter of the requested video slice of the video stream. The first time parameter of the video slice is set to 0. The time parameters of the follow-up other slices are determined according to the slice formats(time lengths of the slices). For example, if time length of each of the video slices is 5 second, the time parameters of the video slices are t=0, t=5, t=10 The server determines the slice data requested by the client according to the time parameters.

In the step S22, the slice data encrypted slice by slice is sent to the client for online playing in the client.

The slice data of the video slice corresponding to the time parameter is sent to the client, and the client decrypts the slice data slice by slice to acquire the video slice for online playing.

In the embodiment, the principle of slicing is applied, it is to slice the original video to acquire a plurality of slices, encrypt each of the slices, and then send the slice data corresponding to the time parameter to the client according to the request from the client. In this way, it is easy to realize the encryption of the video and convenient to switch the code rate and video clarity. The user can encrypt and online play the video stream without purchasing complex commercial DRM.

In an embodiment, as shown in FIG. 5, the step S20 is further implemented as the following steps S201-S202.

In the step S201, the video slice is encrypted slice by slice.

The server slices a original video file to generate the video stream including the plurality of video slices, and encrypts all the video slices respectively by using a preset encryption algorithm to acquire the slice data encrypted slice by slice.

The server may encrypt all the video slices respectively by using the same encryption algorithm, and the client may perform corresponding decryption to acquire each of the video slices for online playing. Or, for the purpose of being corresponding to different permission of the clients, the server may encrypt the video slices by using different encrypting algorithm. For example, the first 50 slices are encrypted by using the first encrypt algorithm encrypt, the subsequent 500 slices are encrypted by using the second encrypt algorithm encrypt. The client is preset to be able to decrypt the slice data encrypted by the first encrypt algorithm, but unable to decrypt the slice data encrypted by the second encrypt algorithm. After acquiring the corresponding authorization from the server, the client is able to decrypt the slice data encrypted by the second encrypt algorithm. In this way, the other part of the video stream is related to different copyright restriction. After the client pays for the copyright of the video stream, the client acquires the corresponding authorization from the server to decrypt the slice data encrypted by the second encrypt algorithm. Thus, it facilitates the copyright management of the video service provider's video resources.

In the step S202, the slice data encrypted slice by slice of the video slice is stored.

In the embodiment, the server slices and encrypts the original video file, and locally stores the slice data encrypted slice by slice.

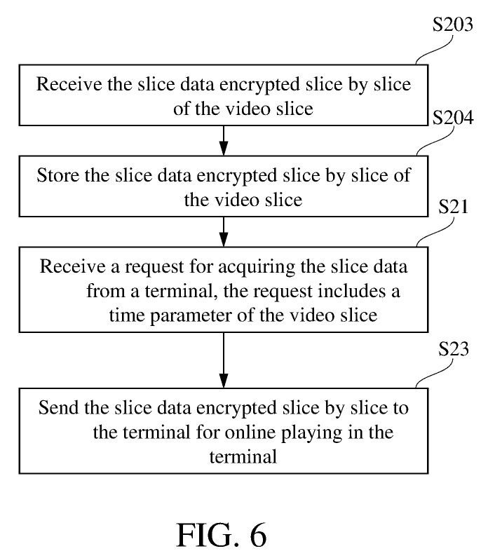

In an embodiment, as shown in FIG. 6, the step S20 is further implemented as the following steps S203-S204.

In the step S203, the slice data encrypted slice by slice of the video slice is received.

The video stream is sliced and encrypted slice by slice by another terminal equipment or another server, like the computer or transcoding server, etc., by which the editorial staff of video service provider use. The video slice may be encrypted slice by slice by the same encrypt algorithm. Or, the video slice may be encrypted slice by slice by using different encrypting algorithms. In this way, different copyright restrictions related to the different parts of the video stream are achieved.

The server receives the slice data encrypted slice by slice and uploaded by the other terminal equipment or the other server.

In the step S204, the slice data encrypted slice by slice of the video slice is stored.

In the embodiment, the server stores the slice data encrypted slice by slice and uploaded by the other terminal equipment or the other server. The operations of slicing the original video file and encrypting slice by slice the original video file may be finished by the other terminal equipment or the other server, In order to achieve balance of loading and prevent excessive pressure in the server.

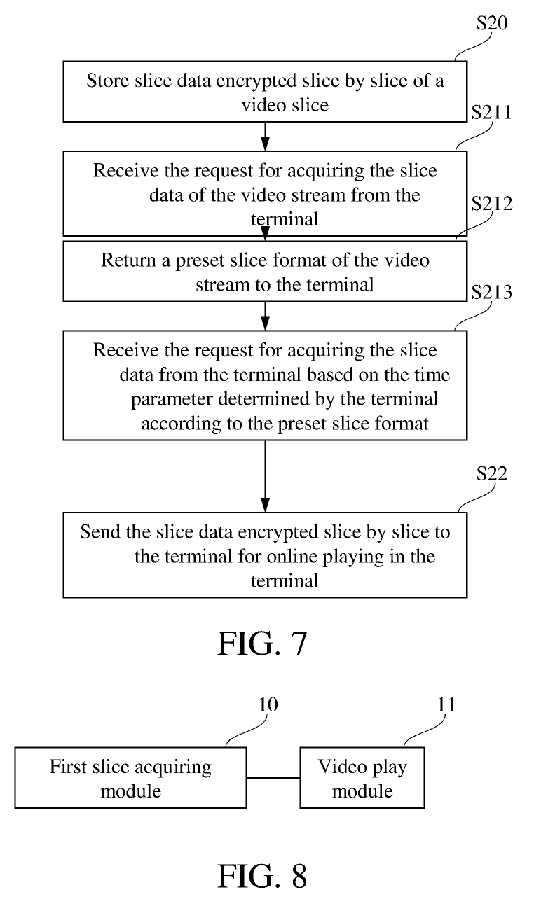

In another embodiment, as shown in FIG. 7, the step S21 is further implemented as the following steps S211-S213.

In the step S211, the request for acquiring the slice data of the video stream is received from the client.

The corresponding the slice data of the video stream is requested according to a video stream flag. For example, a channel flag, program flag and file name, etc.

In the step S212, a preset slice format of the video stream is returned to the client.

When the server slices the original video file, the server usually set a slice interface, the slice interface includes the preset slice format. In the slice format, length of each of the slices may be the same or different. For example, one slice is corresponding to 5 second, or one slice is corresponding to 10 second, and so on. The length of each of the slices may be irregular. For example, the first slice is corresponding to 2 second, the second slice is corresponding to 4 second, and the third and other slices are corresponding to 5 second. The server returns the preset slice format corresponding to the video stream to the client.

In the step S213, the request for acquiring the slice data is received from the client based on the time parameter determined by the client according to the preset slice format.

The request received by the server includes the time parameter determined according to the preset slice format. For example, if the acquired preset slice format of the first slice is 2 second, the acquired preset slice format of the second slice is 4 second, and the acquired preset slice formats of the third and other slices are 5 second, the time parameter used for acquiring slice data are t=0, t=2, t=6, t=11, t=16 Thus, the slice data is acquired according to the time parameter determined.

In the embodiment, the slice format of the video stream is acquired first, because it is beneficial to acquire the slice data fast. Especially when dealing with the video stream with different lengths of slices, it is more beneficial to request the server for the slice data fast and accurately.

The following are electronic apparatus in embodiments. The electronic apparatus are configured to perform the methods in the above embodiments.

FIG. 8 is a block diagram of a device for online playing a video stream in an embodiment of the disclosure. The device is disposed in the terminal equipment. The device includes a first slice acquiring module 10 and a video play module 11.

The first slice acquiring module 10 acquires slice data encrypted slice by slice from a server according to a time parameter of a video slice, and decrypts the acquired slice data to acquire the video slice.

The video play module 11 adds the video slice to a buffer for online playing.

In an embodiment, first slice acquiring module 10 includes a video request submodule, a format acquiring submodule and a first slice acquiring submodule.

The video request submodule sends a request of the slice data of the video stream to the server.

The format acquiring submodule acquires a preset slice format of the video stream from the server.

The first slice acquiring submodule determines the time parameter of the video slice according to the preset slice format and acquires the slice data encrypted slice by slice from the server.

In an embodiment, the first slice acquiring submodule includes a slice amount determining unit and a slice acquiring unit.

The slice amount determining unit determines a slice amount for continuous requests according to a preset buffer time of the buffer and the preset slice format.

The slice acquiring unit acquires the slice data encrypted slice by slice from the server according to the slice amount.

In an embodiment, the device further includes a parameter determining module and a second slice acquiring module.

The parameter determining module determines the time parameter closest to a target timing of an adjusting operation for playing progress when the adjusting operation for the playing progress is detected.

The second slice acquiring module acquires the slice data from the server according to the closest time parameter.

In an embodiment, the second slice acquiring module includes a buffer clearing submodule, a second slice acquiring submodule and a buffer adding submodule.

The buffer clearing submodule clears the buffer.

The second slice acquiring submodule acquires the slice data from the server according to the closest time parameter, and decrypt the acquired slice data to acquire the video slice corresponding to the closest time parameter.

The buffer adding submodule adds the video slice corresponding to the closest time parameter to the buffer.

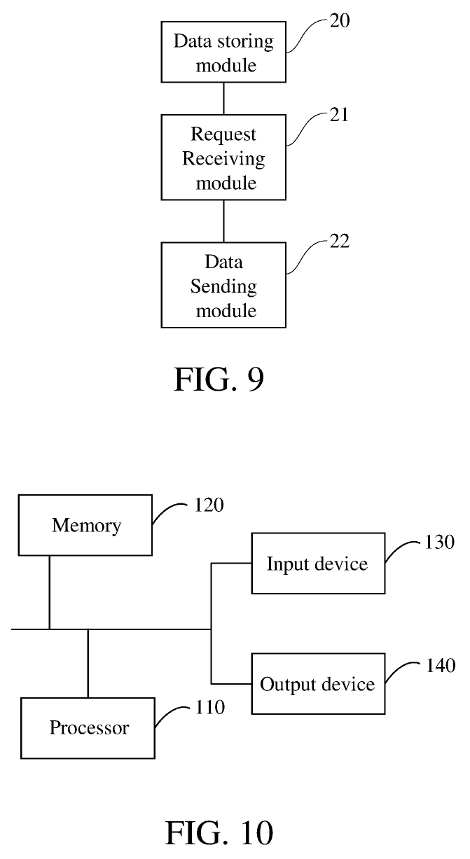

FIG. 9 is a block diagram of a device for online playing a video stream in an embodiment of the disclosure. The device is disposed in the server. The device includes a data storing module 20, request receiving module 21, and a data sending module 22.

The data storing module 20 stores slice data encrypted slice by slice of a video slice.

The request receiving module 21 receives a request for acquiring the slice data from a client, the request includes a time parameter of the video slice.

The data sending module 22 sends the slice data encrypted slice by slice to the client for online playing in the client.

In an embodiment, the data storing module 20 further includes an encrypting submodule and a first storing submodule.

The encrypting submodule encrypts the video slice slice by slice.

The first storing submodule stores the slice data encrypted slice by slice of the video slice.

In an embodiment, the data storing module 20 further includes a data receiving submodule and a second storing submodule.

The data receiving submodule receives the slice data encrypted slice by slice of the video slice.

The second storing submodule stores the slice data encrypted slice by slice of the video slice.

In an embodiment, the request receiving module 21 further includes a first receiving submodule, a format returning submodule and a second receiving submodule.

The first receiving submodule receives the request for acquiring the slice data of the video stream from the client.

The format returning submodule returns a preset slice format of the video stream to the client.

The second receiving submodule receives the request for acquiring the slice data from the client based on the time parameter determined by the client according to the preset slice format.

FIG. 12 is a block diagram of a system for online playing a video stream in an embodiment of the disclosure. The system includes the client 30 and the server 31.

The server 31 stores slice data encrypted slice by slice of a video slice.

The client 30 acquires the slice data encrypted slice by slice from the server 31 according to a time parameter of a video slice.

The server 31 receives a request for acquiring the slice data from the client 30.

The client 30 decrypts the acquired slice data to acquire the video slice, and adds the video slice to a buffer for online playing.

In the embodiment, the principle of slicing is applied, it is to slice the original video to acquire a plurality of slices, encrypt each of the slices, and then send the slice data corresponding to the time parameter to the client according to the request from the client. In this way, it is easy to realize the encryption of the video and convenient to switch the code rate and video clarity. The user can encrypt and online play the video stream without purchasing complex commercial DRM.

The present application further provides a non-volatile computer storage medium. The computer storage medium stores computer-executable instructions, and the computer-executable instructions can carry out the method adaptive to the terminal for online playing a video stream in any one of the embodiments.

The present application further provides a non-volatile computer storage medium. The computer storage medium stores computer-executable instructions, and the computer-executable instructions can carry out the method adaptive to the server for online playing a video stream in any one of the embodiments.

FIG. 10 is a block diagram block diagram of a terminal for online playing a video stream in an embodiment of the disclosure. As shown in FIG. 10, the embodiment of the disclosure further provides an electronic apparatus for online playing a video stream. The electronic apparatus includes:

one or more processor 110 and memory 120. FIG. 10 is an example of one processor.

The electronic apparatus for executing the method for online playing a video stream further includes: input device 130 and output device 140.

The processor 110, memory 120, input device 130 and output device 140 can be connected to each other via a bus or other means. In FIG. 10, they are connected to each other via the bus in this embodiment.

The memory 120 is one kind of non-volatile computer-readable storage mediums applicable to store non-volatile software programs, non-volatile computer-executable programs and modules; for example, the program instructions and the function modules (the first slice acquiring module 10 and the video play module 11 in FIG. 8) corresponding to the method for online playing a video stream in the embodiments are respectively a computer-executable program and a computer-executable module. The processor 110 executes function applications and data processing of the server by running the non-volatile software programs, non-volatile computer-executable programs and modules stored in the memory 120, and thereby the method for online playing a video stream in the aforementioned embodiments are achievable.

The memory 120 can include a program storage block and a data storage block, wherein the program storage block can store an operating system and at least one application program required for a function; the data storage block can store the data created according to the usage of the electronic apparatus for online playing a video stream. Furthermore, the memory 120 can include a high speed random-access memory, and further include a non-volatile memory such as at least one disk storage member, at least one flash memory member and other non-volatile solid state storage member. In some embodiments, the memory 120 can have a remote connection with the processor 110, and such memory can be connected to the electronic apparatus for online playing a video stream by a network. The aforementioned network includes, but not limited to, internet, intranet, local area network, mobile communication network and combination thereof.

The input device 130 can receive digital or character information, and generate a key signal input corresponding to the user setting and the function control of the electronic apparatus for online playing a video stream. The output device 140 can include a displaying unit such as screen.

The one or more modules are stored in the memory 120. When the one or more modules are executed by one or more processor 110, the method for online playing a video stream disclosed in any one of the embodiments is performed.

These products above can perform the method provided in the embodiments of the disclosure which is performed in client, and these products have corresponding function modules to perform the method and provide corresponding advantageous effects. The technical details which are not mentioned in this embodiment can be found in the method provided in the above embodiments.

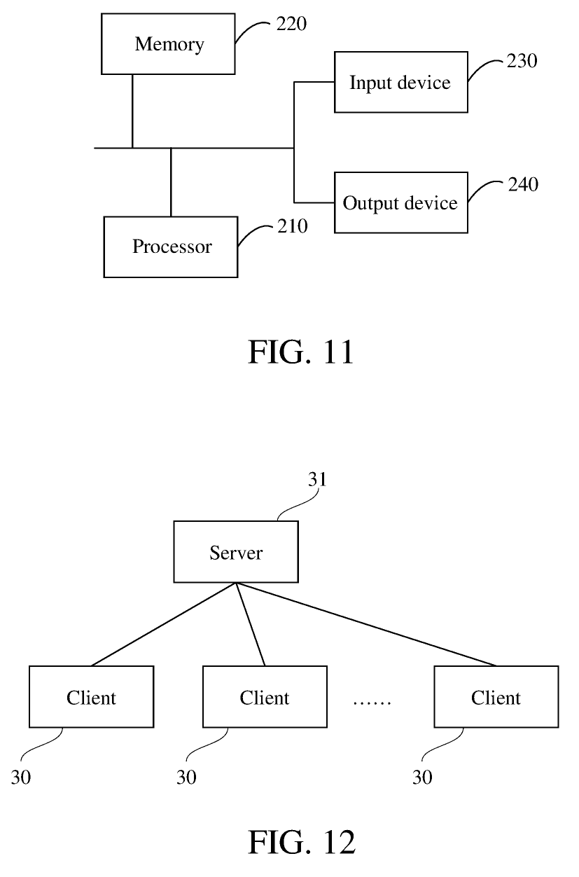

FIG. 11 is a block diagram block diagram of a server for online playing a video stream in an embodiment of the disclosure. As shown in FIG. 11, the embodiment of the disclosure further provides an electronic apparatus for online playing a video stream. The electronic apparatus includes:

one or more processor 210 and memory 220. FIG. 11 is an example of one processor.

The electronic apparatus for executing the method for online playing a video stream further includes: input device 230 and output device 240.

The processor 210, memory 220, input device 230 and output device 240 can be connected to each other via a bus or other means. In FIG. 11, they are connected to each other via the bus in this embodiment.

The memory 220 is one kind of non-volatile computer-readable storage mediums applicable to store non-volatile software programs, non-volatile computer-executable programs and modules; for example, the program instructions and the function modules (the data storing module 20, the request receiving module 21 and the data sending module 22 in FIG. 9) corresponding to the method for online playing a video stream in the embodiments are respectively a computer-executable program and a computer-executable module. The processor 210 executes function applications and data processing of the server by running the non-volatile software programs, non-volatile computer-executable programs and modules stored in the memory 220, and thereby the method for online playing a video stream in the aforementioned embodiments are achievable.

The memory 220 can include a program storage block and a data storage block, wherein the program storage block can store an operating system and at least one application program required for a function; the data storage block can store the data created according to the usage of the electronic apparatus for online playing a video stream. Furthermore, the memory 220 can include a high speed random-access memory, and further include a non-volatile memory such as at least one disk storage member, at least one flash memory member and other non-volatile solid state storage member. In some embodiments, the memory 220 can have a remote connection with the processor 210, and such memory can be connected to the electronic apparatus for online playing a video stream by a network. The aforementioned network includes, but not limited to, internet, intranet, local area network, mobile communication network and combination thereof.

The input device 230 can receive digital or character information, and generate a key signal input corresponding to the user setting and the function control of the electronic apparatus. The output device 240 can include a displaying unit such as screen.

The one or more modules are stored in the memory 220. When the one or more modules are executed by one or more processor 210, the method for online playing a video stream disclosed in any one of the embodiments is performed.

These products above can perform the method provided in the embodiments of the disclosure which is performed in client, and these products have corresponding function modules to perform the method and provide corresponding advantageous effects. The technical details which are not mentioned in this embodiment can be found in the method provided in the above embodiments.

The terminal, electronic apparatus and the server in the embodiments described above are merely illustrative. Wherein the units or modules described above as separate members may or may not be physically separated. The member as the unit or module may be or may not be a physical unit or module. That is, the member as the unit or the module may be located in a place, or may be distributed in a plurality of network units. A part or all of the unit or module can be selected to achieve the purpose of the embodiments according to the actual needs. The person having ordinary skill in the art can understand and implement the embodiments without making creative effort.

Through the above described embodiments, those skilled in the art can clearly understand that various embodiments may be accomplished through software incorporated a necessary universal hardware platform to achieve. Of course, it may also be accomplished through hardware. Based on this understanding, the above technical solution or the part of the contribution to the prior art may be substantially embodied in the form of software products. The computer software product may be stored in a computer-readable storage medium, such as ROM/RAM, disk, CD-ROMs, etc, and may include a number of instructions for making a computer device (may be a personal computer, server, or network device) to perform the various embodiments or portions of the described embodiments of the mentioned method.

Finally, it should be noted that: In order to present the purposes, technical solutions and advantages in the embodiments of the disclosure more clearly, the technical solutions in the embodiments of the disclosure as set forth below are described clearly and completely in conjunction with the accompanying drawings of the embodiments of the disclosure. It is obvious that the described embodiments are merely a part of the embodiments of the disclosure, but not all. Based on the embodiments of the disclosure, all other embodiments obtained by those of ordinary skill in the art without making creative efforts are also within the scope of the disclosure.

What is claimed is:

1. A method for online playing a video stream applied in a terminal, comprising:
acquiring slice data encrypted slice by slice from a server according to a time parameter of a video slice, and decrypting the acquired slice data to acquire the video slice; and
adding the video slice to a buffer for online playing.

2. The method according to claim 1, wherein acquiring the slice data encrypted slice by slice from the server according to the time parameter of the video slice comprises:
sending a request of the slice data of the video stream to the server;
acquiring a preset slice format of the video stream from the server; and
determining the time parameter of the video slice according to the preset slice format and acquiring the slice data encrypted slice by slice from the server.

3. The method according to claim 2, wherein determining the video slice of the time parameter according to the preset slice format and acquiring the slice data encrypted slice by slice from the server comprises:
determining a slice amount for continuous requests according to a preset buffer time of the buffer and the preset slice format; and
acquiring the slice data encrypted slice by slice from the server according to the slice amount.

4. The method according to claim 1, further comprising:
determining the time parameter closest to a target timing of an adjusting operation for playing progress when the adjusting operation for the playing progress is detected; and
acquiring the slice data from the server according to the closest time parameter.

5. The method according to claim 4, wherein acquiring the slice data from the server according to the closest time parameter comprises:
clearing the buffer;
acquiring the slice data from the server according to the closest time parameter, and decrypting the acquired slice data to acquire the video slice corresponding to the closest time parameter; and
adding the video slice corresponding to the closest time parameter to the buffer.

6. A method for online playing a video stream applied in a server, comprising:
storing slice data encrypted slice by slice of a video slice;
receiving a request for acquiring the slice data from a terminal, the request comprising a time parameter of the video slice; and
sending the slice data encrypted slice by slice to the terminal for online playing in the terminal.

7. The method according to claim 6, wherein before storing slice data encrypted slice by slice of the video slice, further comprises:
encrypting the video slice slice by slice by using different encrypting algorithm.

8. The method according to claim 6, wherein receiving the request for acquiring the slice data from the terminal comprises:
receiving the request for acquiring the slice data of the video stream from the terminal;
returning a preset slice format of the video stream to the terminal; and
receiving the request for acquiring the slice data from the client based on the time parameter determined by the client according to the preset slice format.

9. A terminal, comprising:
at least one processor; and
a memory communicably connected with the at least one processor, wherein the memory stores instructions executable by the at least one processor, and execution of the instructions by the at least one processor causes the at least one processor to:
acquire slice data encrypted slice by slice from a server according to a time parameter of a video slice, and decrypt the acquired slice data to acquire the video slice; and
add the video slice to a buffer for online playing.

10. The terminal according to claim 9, wherein the at least one processor is further caused to:
send a request of the slice data of the video stream to the server;
acquire a preset slice format of the video stream from the server; and
determine the time parameter of the video slice according to the preset slice format and acquire the slice data encrypted slice by slice from the server.

11. The terminal according to claim 10, wherein the at least one processor is further caused to:
determine a slice amount for continuous requests according to a preset buffer time of the buffer and the preset slice format; and
acquire the slice data encrypted slice by slice from the server according to the slice amount.

12. The terminal according to claim 9, wherein the at least one processor is further caused to:
determine the time parameter closest to a target timing of an adjusting operation for playing progress when the adjusting operation for the playing progress is detected; and
acquire the slice data from the server according to the closest time parameter.

13. The terminal according to claim 12, wherein the at least one processor is further caused to:
clear the buffer;
acquire the slice data from the server according to the closest time parameter, and decrypt the acquired slice data to acquire the video slice corresponding to the closest time parameter; and
add the video slice corresponding to the closest time parameter to the buffer.

14. A terminal, comprising:
at least one processor; and
a memory communicably connected with the at least one processor, wherein the memory stores instructions executable by the at least one processor, and execution of the instructions by the at least one processor causes the at least one processor to:
store slice data encrypted slice by slice of a video slice;
receive a request for acquiring the slice data from a terminal, the request comprising a time parameter of the video slice; and
send the slice data encrypted slice by slice to the terminal for online playing in the terminal.

15. The terminal according to claim 14, wherein the at least one processor is further caused to:
encrypt the video slice slice by slice by using different encrypting algorithm.

16. The terminal according to claim 14, wherein the at least one processor is further caused to:
receive the request for acquiring the slice data of the video stream from the terminal;
return a preset slice format of the video stream to the terminal; and
receive the request for acquiring the slice data from the client based on the time parameter determined by the client according to the preset slice format.
